(19) United States
(12) Patent Application Publication
(10) Pub. No.: US 2026/0312335 A1
(43) Pub. Date: Oct. 8, 2026

(54) CONNECTOR POSITION ASSURANCE INSERT

(71) Applicant: Molex, LLC, Lisle, IL (US)

(72) Inventor: Nithish Sukumar, Erode (IN)

(21) Appl. No.: 19/640,629

(22) Filed: Apr. 7, 2026

(30) Foreign Application Priority Data
Apr. 8, 2025 (IN) 202541034324

(51) Int. Cl. H01R 13/627; H01R 13/639; H01R 24/28; H01R 24/62

(52) U.S. Cl. CPC H01R 13/6272; H01R 13/639; H01R 24/28; H01R 24/62; H01R 2201/06; H01R 2201/26

(57) ABSTRACT

A connector position assurance insert for deployment in a connector with a lever is disclosed. The connector position assurance insert includes a pre-engagement retention feature that engages with the lever to prevent separation of the connector position assurance insert from a housing of the connector in an unlocked position of the position assurance insert.

### BACKGROUND

Connectors facilitate data and/or power transfer between devices. For example, a peripheral device may be connected to a computer or other host (e.g., camera) to facilitate data transfer to or from the peripheral device. Power may be delivered to the peripheral device through the connection, as well. For example, a cable from the peripheral device (e.g., keyboard, mouse, external hard drive) may terminate at a connector that can couple to a corresponding connector of the computer. As another example, the host device may be in the form of an electronic control unit (ECU) of a vehicle, and the peripheral device may be part of the infotainment system.

Standards like the Universal Serial Bus (USB) standard define the interface between a host (e.g., computer, ECU) and peripheral. Thus, a host that has a connector based on a given standard may interface with different peripheral devices with corresponding connectors that comply with the same standard.

### SUMMARY

Certain aspects of the concepts and embodiments described herein are summarized below. The aspects are representative and not exhaustively listed. In alternate embodiments, certain features and elements can be added, omitted, and interchanged with each other. Additionally, variations, extensions, and modifications to the example embodiments can be achieved by those skilled in the art without departing from the concepts, so as to encompass equivalent and related structures.

Various embodiments are disclosed for a connector placement assurance insert for deployment in a connector. An example connector includes a housing with a cable end, a connection end, opposite the cable end, and a lever. The lever includes an actuator bar closest to the cable end, an engagement bar closest to the connection end, and a first bar and a second bar extending between the actuator bar and the engagement bar with an open area framed by the actuator bar, the first bar, the engagement bar, and the second bar. An exemplary connector position assurance insert extends between the cable end and the connection end of the housing. The connector position assurance insert includes a first retaining element and a second retaining element, on an opposite side of the connector position assurance insert from the first retaining element. The first retaining element and the second retaining element are arranged to engage the first bar and the second bar of the lever, respectively, from opposite sides of the open area. The first retaining element and the second retaining element are pivot points for the connector position assurance insert to rotate relative to the lever.

In some aspects, the first retaining element and the second retaining element are snap-fit latches. The connector position assurance insert can include a main body extending in an axial direction between the cable end and the connection end of the housing, a tail bar at an end closest to the cable end of the housing that extends in a lateral direction on each side of the main body, and a nose at an end closest to the connection end. In some aspects, a first leg and a second leg extend in a depth direction from each side of the main body and comprise the first retaining element and the second retaining element, respectively, at a depth farthest from the main body. A gap between the first leg and the second leg facilitates a flexed state of the first leg and the second leg inward toward each other. The first retaining element and the second retaining element fit in the open area between the first bar and the second bar of the lever in the flexed state of the first leg and the second leg. In some aspects, the first retaining element and the second retaining element are on an opposite side of the first bar and the second bar, in the depth direction, from the main body.

In other aspects, a first protruding guide and a second protruding guide extend from the main body in opposite lateral directions. The first protruding guide can overlap, in the lateral direction, with a first ledge extending toward the open area from the first bar. The second protruding guide can overlap, in the lateral direction, with a second ledge extending toward the open area from the second bar.

In other aspects, a first back leg and a second back leg extend from the tail bar in a depth direction and toward the cable end of the housing. A first wedge stop and a second wedge stop can extend in the depth direction from a portion of the first back leg and a portion of the second back leg, respectively. A first connecting bar of the housing can have a connection to the actuator bar of the lever at a first end of the first connecting bar, closest to the cable end of the housing. A first space between the first connecting bar and the first bar of the lever can be blocked by a first block formed by the connection to the actuator bar at the first end of the first connecting bar. A second connecting bar of the housing can have a connection to the actuator bar of the lever at a first end of the second connecting bar, closest to the cable end of the housing. A second space between the second connecting bar and the second bar of the lever can be blocked by a second block formed by the connection to the actuator bar at the first end of the second connecting bar. In a locked position of the connector position assurance insert, in which disengagement of the connector from a receptacle is prevented, the first wedge stop can be held in the first space by the first block and the second wedge stop can be held in the second space by the second block. In an unlocked position of the connector position assurance insert, the first wedge stop and the second wedge stop can be closer to the cable end of the housing than the first block and the second block are to the cable end.

An example connector position assurance insert for deployment in a connector includes a main body extending in an axial direction between a first end and a second end, a nose at the first end, a tail bar at the second end, a first leg on a first side of the main body, and a second leg on a second side, opposite the first side, of the main body, the first leg and the second leg extending in a depth direction from the main body and comprising a first retaining element and a second retaining element, respectively, at a depth farthest from the main body. The first retaining element and the second retaining element can be pivot points for rotation of the connector position assurance insert.

The first retaining element and the second retaining element can be snap-fit latches that hold the connector position assurance insert in the connector. The connector position assurance insert can rotate from an unlocked position to a locked position in the connector.

In some aspects, the connector position assurance insert can include a first back leg and a second back leg extending in a depth direction from the tail bar, a first wedge stop extending from a portion of the first back leg, and a second wedge stop extending from a portion of the second back leg. The first wedge stop and the second wedge stop can be held in a first space and a second space, respectively, in the locked position of the connector. The first wedge stop and the second wedge stop can be rotated into a first space and a second space, respectively, when the connector position assurance insert rotates from the unlocked position to the locked position in the connector.

In other aspects, the connector position assurance insert can include a first protruding guide and a second protruding guide extending laterally from opposite sides of the main body. The first protruding guide can be between the nose and the first leg and the second protruding guide can be between the nose and the second leg. In other aspects, a tab can extend outside a housing of the connector when the connector position assurance insert is deployed in the connector.

An example connector include a housing. The housing includes a cable end, a connection end, opposite the cable end, and a lever. The lever includes an actuator bar closest to the cable end, an engagement bar closest to the connection end, and a first connecting bar and a second connecting bar extending between the actuator bar and the engagement bar with an open area framed by the actuator bar, the first bar, the engagement bar, and the second bar. The connector also includes a connector position assurance (CPA) insert. The CPA insert includes a main body extending between an end closest to the cable end and an end closest to the connection end of the housing when inserted in the housing, and a pre-engagement retention feature arranged between the end closest to the cable end and the end closest to the connection end to be positioned in the open area and engage the actuator bar of the lever in an unlocked position of the CPA insert. The actuator bar prevents separation of the CPA insert from the housing.

In some aspects, the pre-engagement retention feature is a projection extending from the main body in a direction perpendicular to the direction in which the main body extends. In some aspects, the CPA insert also includes a nose at the end of the main body closest to the connection end of the housing when inserted in the housing. In the unlocked position of the CPA insert, the nose may be arranged to be positioned in the open area and engaged with the engagement bar of the lever. In a locked position of the CPA insert, a first section of the CPA insert may be arranged to be positioned over the engagement bar of the lever.

In some aspects, the CPA insert also includes a tab at the end of the main body closest to the cable end of the housing when inserted in the housing. In a locked position of the CPA insert, the tab may be positioned to engage with the actuator bar of the lever and prevent the CPA insert from moving further into the housing. In some aspects, the CPA insert also includes guiding features on each side of the main body. Each guiding feature may be positioned to slide between the first connecting bar or the second connecting bar of the lever and a wall of the housing.

An example connector position assurance (CPA) insert for deployment in a connector includes a main body extending in an axial direction between a first end and a second end, a nose at the first end, a tab at the second end, and guiding features on each side of the main body. Each of the guiding features extends parallel to the main body and is projected in a direction perpendicular to the axial direction.

In some aspects, the CPA insert also includes a pre-engagement retention feature arranged between the nose and the tab. The pre-engagement retention feature extends across the main body and is projected in a direction perpendicular to the axial direction. The main body may include a curved section.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1A is a perspective view of a connector with a connector position assurance (CPA) insert in an unlocked position according to various embodiments of the present disclosure.

FIG. 1B is a perspective view of the connector of FIG. 1A with the CPA insert in a locked position according to various embodiments of the present disclosure.

FIG. 2 shows a plug of the connector of FIGS. 1A and 1B and a socket of the receptacle.

FIG. 3A is a partial perspective view of the connector without the CPA insert to show a connection between the lever and housing according to various embodiments of the present disclosure.

FIG. 3B is a cross-sectional view of the connector without the CPA insert to show aspects of the lever according to various embodiments of the present disclosure.

FIG. 4 is a cross-sectional view of FIG. 1A with the connector coupled to the receptacle and the CPA insert in the unlocked position according to various embodiments of the present disclosure.

FIG. 5 is a cross-sectional view of FIG. 1B with the connector coupled to the receptacle and the CPA insert in the locked position according to various embodiments of the present disclosure.

FIG. 6 is an expanded cross-sectional view at the cable end of the housing of the connector of FIG. 1B with the CPA insert in the locked position according to various embodiments.

FIG. 7A is an elevation view of the CPA insert from a cable end of the housing according to various embodiments of the present disclosure.

FIG. 7B is a perspective view of the CPA insert of FIG. 7A.

FIG. 7C is a perspective view of the CPA insert of FIG. 7A.

FIG. 8 is a flow diagram illustrating deployment of the CPA insert in the housing of the connector of FIG. 1A according to several embodiments of the present disclosure.

FIG. 9 shows cross-sectional views of the CPA insert deployment flow illustrated in FIG. 8.

FIG. 10 is a partial perspective view clarifying a role of the protruding guides during the deployment of the CPA insert illustrated in FIG. 8.

FIG. 11 is a perspective view of a CPA insert according to various embodiments.

FIG. 12 is a cross-sectional view of a connector coupled with the receptacle, showing an unlocked position of the CPA insert of FIG. 11.

FIG. 13 is a cross-sectional view of a connector coupled with the receptacle, showing a locked position of the CPA insert of FIG. 11.

FIG. 14 is a perspective view of a connector with the CPA insert of FIG. 11.

### DETAILED DESCRIPTION

As noted above, a peripheral device may interconnect with a host through corresponding connectors. The peripheral device may have a connector with connection pins protruding from a housing. The protruding connection pins may be surrounded by a shield, and the shield and connection pins, which may be referred to as a plug, of the connector may be inserted into an opening, which may be referred to as a socket, of the complementary connector, referred to as a receptacle, of the host.

As also noted, the connector of the peripheral device may comply with a particular standard. The USB standard, for example, includes multiple types, such as the original USB, USB 2.0, USB A, USB B, and USB C, as well as smaller versions of some types, such as the USB mini A, USB mini B, and USB micro. In some vehicle systems, a peripheral with a USB mini B connector may be coupled to a host, such as the ECU.

While some connectors are simply pushed into and pulled out of the receptacle of the host, others may include a primary mechanism (e.g., latch, lever) that prevents simply pulling the connector to disengage the peripheral device from the host. Some connectors may additionally include a component for connector position assurance (CPA). In this case, the CPA component imposes a second locking/unlocking step. The CPA component may have an unlocked position in which the connector may be disengaged from the receptacle using only the primary mechanism and a locked position in which the connector is prevented from disengaging from the receptacle if both the CPA component and the primary mechanism are not opened.

The USB mini B connector used in vehicles, for example, typically includes a lever as a primary mechanism but does not additionally include a component for CPA. Adopting an existing CPA design from another connector for use with the USB mini B connector requires modifying the housing of the connector. This is because the guiding and retention features of the housing that existing CPA components utilize are not part of the USB mini B connector housing.

In the context outlined above, aspects of CPA inserts are described. A CPA insert may be retrofitted in the USB mini B connector, which currently includes only a lever to secure the connector to the receptacle, without any modification to the current USB mini B connector housing. The CPA insert may include features to couple the CPA insert to the lever of the connector. These features may act as a pivot point around which the CPA insert may rotate relative to the tab to transition to the locked position. The CPA insert may additionally include features to guide the insert into the housing of the connector and to secure the lever in the locked position. These and other aspects of the embodiments are described below. The USB mini B connector is specifically discussed herein for explanatory purposes but is not intended to limit the embodiments of the present disclosure.

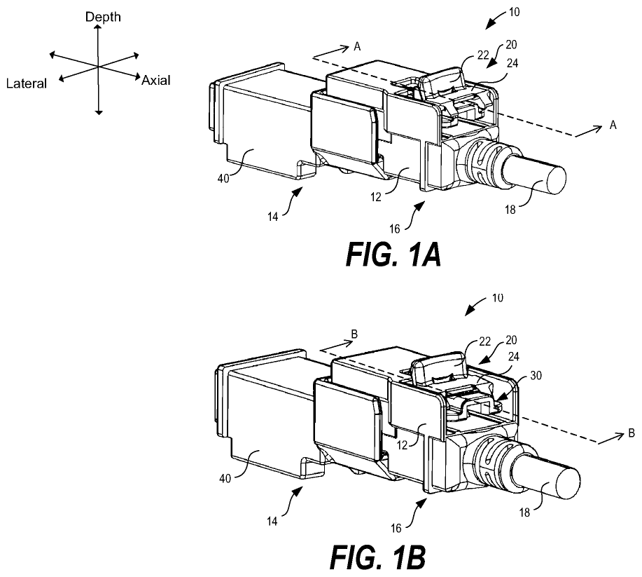

Turning to the drawings, FIG. 1A is a perspective view of a connector 10 with a CPA insert 20 in an unlocked position according to various embodiments of the present disclosure. FIG. 1B is a perspective view of the connector 10 of FIG. 1A with the CPA insert 20 in a locked position. The connector 10 has a housing 12 and is shown coupled to a receptacle 40 of a host (not shown) at the connection end 14 of the housing 12. At the opposite end, the cable end 16 of the housing 12, a portion of a cable 18 is shown entering the housing 12 from a peripheral device (not shown). As indicated, the housing 12 extends from the connection end 14 to the cable end 16 in an axial direction.

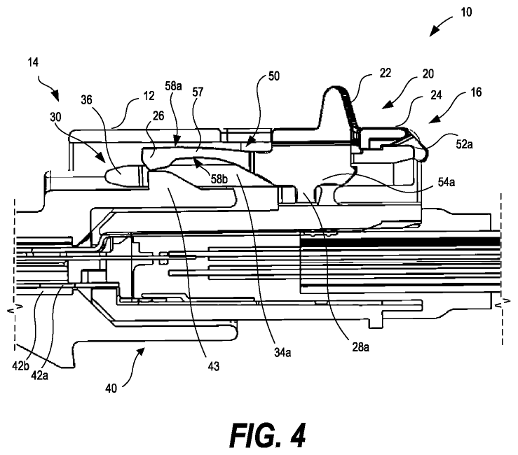

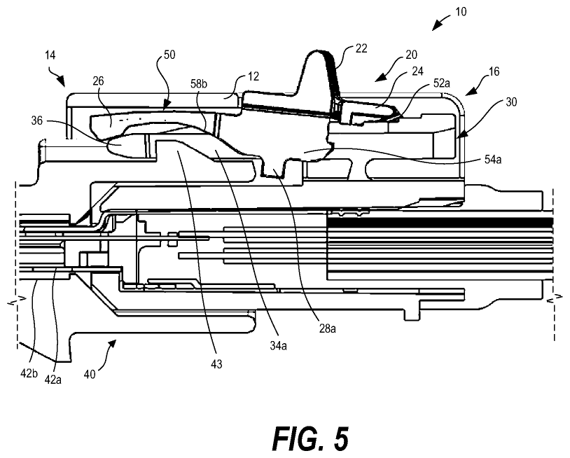

In FIG. 1A, a CPA insert 20 is shown inserted in the housing 12 of the connector 10 and is in the unlocked position. A tab 22 and a tail bar 24 of the CPA insert 20 are shown. The tab 22, in the position shown in FIG. 1A, may be pushed toward the receptacle 40 to put the CPA insert 20 in the locked position shown in FIG. 1B. Subsequently, the tab 22, in the position shown in FIG. 1B, may be pulled back toward the cable end 16 of the housing 12 to put the CPA insert 20 back in the unlocked position shown in FIG. 1A. With the CPA insert 20 in the locked position, a lever 30 of the connector 10 is visible in FIG. 1B. The cross-section A-A indicated in FIG. 1A is shown in FIG. 4, and the cross-section B-B indicated in FIG. 1B is shown in FIG. 5.

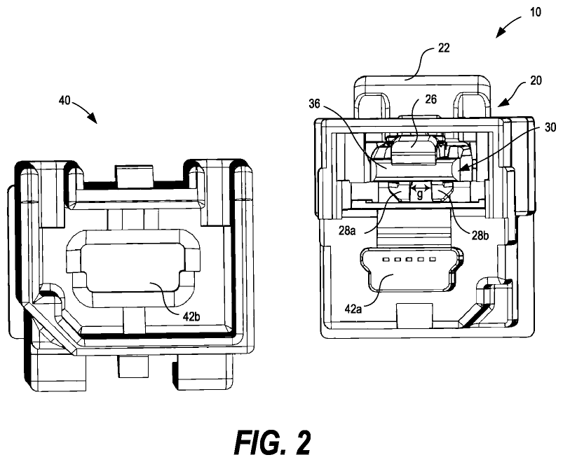

FIG. 2 shows a plug 42a of the connector 10 of FIGS. 1A and 1B and a socket 42b of the receptacle 40. The plug 42a extends from the connection end 14 of the housing 12 of the connector 10 and is keyed to the socket 42b, such that the plug 42a fits into the socket 42b of the receptacle 40 in only one orientation. The view of the connection end 14 of the connector 10 shows aspects of the lever 30 and the CPA insert 20 that are further discussed below. Specifically, the nose 26 of the CPA insert 20 is shown above the engagement bar 36 of the lever 30. The retaining elements 28a, 28b of the CPA insert 20 are also visible below the engagement bar 36. As indicated, there is a gap “g” between the retaining elements 28a, 28b of the CPA insert 20.

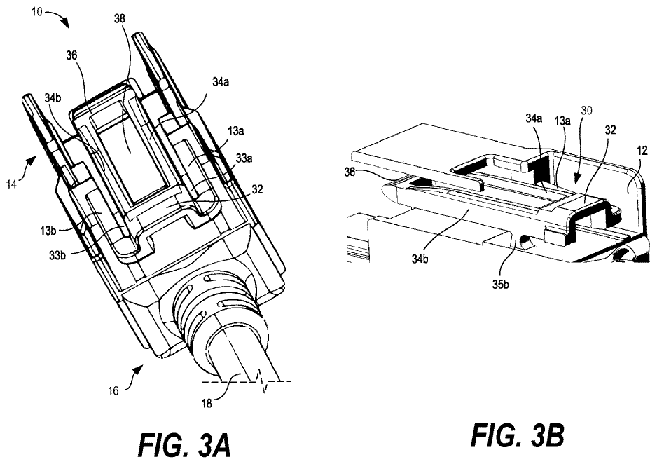

FIG. 3A is a partial perspective view of the connector 10 without the CPA insert 20 to show a connection between the lever 30 and housing 12 according to various embodiments of the present disclosure. A cover portion at the connection end 14 of the housing 12 is omitted to result in the view of FIG. 3A for explanatory purposes. The engagement bar 36 of the lever 30 is shown toward the connection end 14 of the housing 12. At the opposite end, toward the cable end 16 of the housing 12, the lever 30 includes an actuator bar 32. A first bar 34a and a second bar 34b extend in an axial direction between the actuator bar 32 and the engagement bar 36. The first bar 34a, the second bar 34b, the actuator bar 32, and the engagement bar 36 define and frame an open area 38. As discussed below, the open area 38 accommodates aspects of the CPA insert 20.

FIG. 3A also shows a first connecting bar 13a and a second connecting bar 13b that connect the lever 30 to the housing 12. Only the first connecting bar 13a is visible in FIG. 3B. The sides of the actuator bar 32 extend in the depth direction and connect with one end of the first connecting bar 13a on one side and to one end of the second connecting bar 13b on an opposite side. The other end of first connecting bar 13a and the second connecting bar 13b may connect to opposite sides of the housing 12. There is a first space 33a between the lever 30 and the first connecting bar 13a and a second space 33b between the lever 30 and the second connecting bar 13b, as illustrated in FIG. 3A.

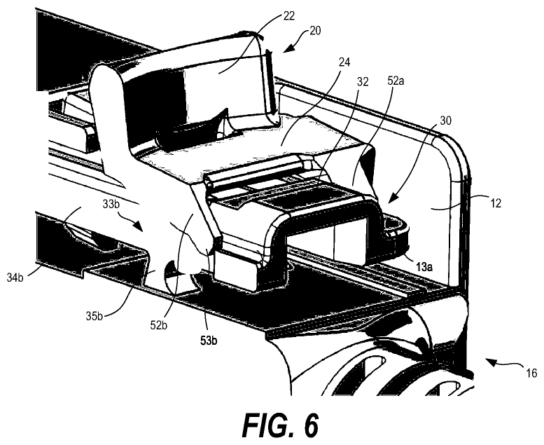

Specifically, the first space 33a is between the first bar 34a of the lever 30 and the first connecting bar 13a, and the second space 33b is between the second bar 34b of the lever 30 and the second connecting bar 13b. The first space 33a is blocked by the connection between the first connecting bar 13a and the actuator bar 32 on an end of the first connecting bar 13a that is closest to the cable end 16 of the housing 12. Similarly, the second space 33b is blocked by the connection between the second connecting bar 13b and the actuator bar 32 on an end of the second connecting bar 13b that is closest to the cable end 16 of the housing 12. As discussed below with reference to FIGS. 5 and 6, the first space 33a and the second space 33b are used to keep the CPA insert 20 in a closed position.

FIG. 3B is a cross-sectional view of the connector 10 without the CPA insert 20 to show aspects of the lever 30 according to various embodiments of the present disclosure. As previously noted, the lever 30 is shaped as a frame with the actuator bar 32, engagement bar 36, first bar 34a, and second bar 34b forming the four sides of the frame and with an open area 38 within the frame. The lever 30 has a first fulcrum 35a below the first bar 34a (not visible in FIG. 3B) and a second fulcrum 35b below the second bar 34b that facilitate operation of the lever 30 in a seesaw manner.

The actuator bar 32 of the lever 30 may be pushed down, according to the orientation shown in FIG. 3A, to raise the engagement bar 36 at the other end of the lever 30. The plug 42a of the connector 10 may be inserted into the socket 42b of the receptacle 40 with the actuator bar 32 pressed down (i.e., with the engagement bar 36 raised). As made clearer by the view in FIG. 4, the actuator bar 32 must be pressed down during engagement of the connector 10 and the receptacle 40 in order to position the lever 30 outside the housing of the receptacle 40 and prevent the engagement bar 36 of the lever 30 from blocking insertion of the plug 42a into the socket 42b.

FIG. 4 is a cross-sectional view of FIG. 1A with the connector 10 coupled to the receptacle 40 and the CPA insert 20 in the unlocked position. As indicated by A-A in FIG. 1A, the cross-section shown in FIG. 4 is taken in the axial direction from the connection end 14 to the cable end 16 of the housing 12 through the open area 38 between the first bar 34a and the second bar 34b of the lever 30. Thus, the first bar 34a is visible but the second bar 34b, which is part of the cutaway portions, is not visible in FIG. 4. A portion of the receptacle 40 is visible in FIG. 4, and the cross-sectional view shows a ridge 43 extending from the housing of the receptacle 40.

When the connector 10 is engaged with the receptacle 40, as shown in FIGS. 1A and 4, the ridge 43 extends laterally within the open area 38 of the connector 10, between the first bar 34a and the second bar 34b of the lever 30. As discussed with reference to FIG. 3B, the actuator bar 32 of the lever 30 may be pushed down during coupling of the connector 10 with the receptacle 40. This raises the engagement bar 36 and allows the engagement bar 36 to be moved in the axial direction, past the ridge 43 of the receptacle 40. When the actuator bar 32 is released after coupling is complete, the engagement bar 36 returns to its default height, shown in FIG. 4, and is prevented from reverse movement in the axial direction. That is, the ridge 43 of the receptacle 40 acts as a catch, preventing backout of the engagement bar 36 of the lever 30 and, thus, retaining the plug 42a in the socket 42b. This illustrates an existing retention mechanism of the USB mini B connector, for example.

The nose 26 of the CPA insert 20 is shown positioned on the ridge 43. In this position, in which the CPA insert 20 is unlocked, the engagement bar 36 is not prevented from being raised by pushing on the actuator bar 32. Thus, the actuator bar 32 alone may be operated to raise the engagement bar 36 so that it is above the ridge 43 and the connector 10 may disengage from the receptacle 40. FIG. 5 illustrates the use of the CPA insert 20 as a secondary retention mechanism, as described below.

The cross-sectional view in FIG. 4 also shows aspects of the CPA insert 20. The CPA insert 20 has a main body 50 extending in the axial direction from an end closest to the cable end 16 of the housing 12 of the connector 10 to an opposite end, closest to the connection end 14 of the housing 12. The main body 50 has two sides with surfaces 57 (one of which is visible in FIG. 4) that are parallel to the first bar 34a and the second bar 34b. The main body 50 also has a top surface 58a and a bottom surface 58b, opposite the top surface 58a, according to the orientation shown in FIG. 4. The bottom surface 58b of the main body 50 is curved, as discussed below.

The nose 26 of the CPA insert 20 is at the end of the main body 50 closest to the connection end 14 of the housing 12, and the tail bar 24 of the CPA insert 20 is at the end of the main body 50 closest to the cable end 16 of the housing 12. The tail bar 24 extends laterally on each side of the main body 50 and is the widest part of the CPA insert 20 in the lateral direction. The tab 22 extends in the depth direction from the main body 50, as shown.

Legs 54a, 54b extend in a depth direction from each side of the main body 50 and terminate, respectively, in the retaining elements 28a, 28b, which are farthest from the main body 50 in the depth direction. The tab 22 and the legs 54a, 54b extend in opposite depth directions from the main body 50. The leg 54a and its retaining element 28a are visible in the cross-sectional view of FIG. 4. The leg 54a is shown extending through the open area 38 in the depth direction such that its retaining element 28a is below the first bar 34a of the lever 30 according to the orientation shown in FIG. 4.

The legs 54a, 54b and the retaining elements 28a, 28b at the ends of the legs 54a, 54b have a gap (e.g., gap “g” indicated in FIG. 2) between them that facilitates flexing inward, toward each other. As shown in FIG. 2, for example, the retaining elements 28a, 28b at the ends of the legs 54a, 54b may be snap-fit latches with an “L” shape that project outward away from each other. Thus, the ends of the legs 54a, 54b (i.e., retaining elements 28a, 28b) are the widest part of the legs 54a, 54b in the lateral direction.

During insertion of the CPA insert 20 into the housing 12, the legs 54a, 54b are flexed inward to decrease the gap therebetween (i.e., width in the lateral direction) and thereby allow the retaining elements 28a, 28b to fit through the open area 38 between the first bar 34a and the second bar 34b of the lever 30. Once the retaining elements 28a, 28b (e.g., snap-fit latches with the outward projections) pass the first bar 34a and the second bar 34b, the legs 54a, 54b snap outward to their unloaded position, away from each other, such that the projecting portions of the snap-fit latches catch on the bottom edge surfaces of the first bar 34a and the second bar 34b, respectively, as shown in FIG. 2, for example. The retaining elements 28a, 28b prevent separation of the CPA insert 20 from the lever 30 and housing 12 of the connector 10 unless the legs 54a, 54b are pushed together to facilitate pullout of the retaining elements 28a, 28b through the open area 38.

The curved bottom surface 58b is curved from the legs 54a, 54b that extend in the depth direction to the nose 26, which may be thicker than the main body 50 in the depth direction, as shown in FIG. 4. In other embodiments, the nose 26 may be the same thickness as or thinner than the main body 50. The thickness (depth dimension) of the nose 26 may be limited to fit between the cover of the housing 12 and the ridge 43 (as shown in FIG. 4) and between the cover of the housing 12 and the engagement bar 36 (as shown in FIG. 5). The width (lateral dimension) of the main body 50 and nose 26 may be limited to fit within the open area 38 between the first bar 34a and the second bar 34b of the lever 30. Protruding guides 56a, 56b extending laterally from the sides of the main body 50 are not visible in FIG. 4. As discussed with reference to FIG. 10, these protruding guides 56a, 56b prevent the CPA insert 20 from over-travelling (e.g., over-rotating) within the housing 12 during insertion of the CPA insert 20 into the housing 12 of the connector 10.

FIG. 5 is a cross-sectional view of FIG. 1B with the connector 10 coupled to the receptacle 40 and the CPA insert 20 in the locked position according to various embodiments of the present disclosure. The cross section is indicated by B-B in FIG. 1B. Although the position of the CPA insert 20 differs, the view is similar to the view in FIG. 4 and all the components discussed with reference to FIG. 4 are not detailed again. As noted with reference to FIG. 4, the engagement bar 36 of the lever 30 is held in place (i.e., axial movement toward the cable end 16 is prevented) by the ridge 43 of the receptacle 40. This may be a mechanism to retain the plug 42a of the connector 10 in the socket 42b of the receptacle 40. The CPA insert 20 acts as an additional retention mechanism.

As a comparison of FIGS. 4 and 5 indicates, when the tab 22 of the CPA insert 20 is moved toward the connection end 14 of the housing 12 to put the CPA insert 20 in the locked position shown in FIG. 5, the retaining elements 28a, 28b act as pivot points and the CPA insert 20 rotates relative to the lever 30. As shown in FIG. 5, the nose 26 of the CPA insert 20 rotates up, above and on the engagement bar 36 of the lever 30. The CPA insert 20 is held in this position by wedge stops 53a, 53b, extending from back legs 52a, 52b, which extend from the tail bar 24 towards the cable end 16 of the housing 12. The wedge stops 53a, 53b are further discussed with reference to FIG. 6.

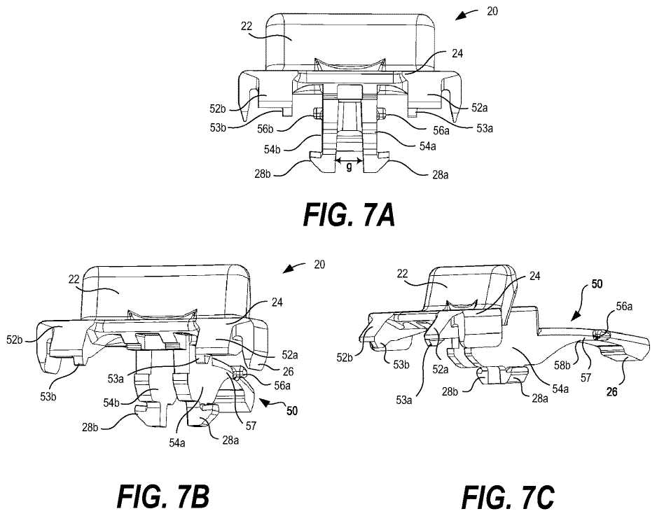

In the final locked position, the nose 26 of the CPA insert 20 is seated on the engagement bar 36 of the lever 30 and held in this position based on the wedge stops 53a, 53b (see FIGS. 6 and 7A-7C). With the nose 26 in this position, the engagement bar 36 is prevented from being raised up by pressing down on the actuator bar 32 of the lever 30. The nose 26 of the CPA insert 20 may even prevent a forced manual raising of the engagement bar 36 with a tool (e.g., screwdriver). This is because raising the engagement bar 36 sufficiently to pull back the ridge 43 of the receptacle 40 may be prevented by the nose 26 becoming sandwiched between the engagement bar 36 and the cover portion of the housing 12 above the engagement bar 36. The nose 26 acts as a mechanical interference to prevent the engagement bar 36 from raising up from the position shown.

As a result, the locked position of the lever 30 is reinforced by the locked position of the CPA insert 20. To decouple the connector 10 from the receptacle 40, the tab 22 of the CPA insert 20 must first be pulled back to move the nose 26 of the CPA insert 20 off the engagement bar 36. Thereafter, the engagement bar 36 may then be raised by pushing down on the actuator bar 32. Thus, as previously noted, the CPA insert 20 provides a secondary retention mechanism for the coupling between the connector 10 and receptacle 40.

The position of the nose 26 of the CPA insert 20 on the engagement bar 36 of the lever 30 when the CPA insert 20 is in the locked position (as in FIG. 5) indicates that the CPA insert 20 must be in the unlocked position (as in FIG. 4) to facilitate engagement between the connector 10 and the receptacle 40. That is, as noted above, the ridge 43 of the receptacle 40 passes below the engagement bar 36 and pushes the nose 26 of the CPA insert 20 up during engagement of the connector 10 with the receptacle 40. The movement of the ridge 43 is facilitated by the engagement bar 36 being raised by pushing down on the actuator bar 32, which is only possible in the unlocked position of the CPA insert 20, as noted above.

FIG. 6 is an expanded cross-sectional view at the cable end 16 of the connector 10 of FIG. 1B, which shows the CPA insert 20 in the locked position. The cross-section is taken through the second space 33b between the second bar 34b of the lever 30 and the second connecting bar 13b. The second connecting bar 13b is cut away to show the second space 33b and the second bar 34b of the lever 30. A portion of the second connecting bar 13b which connects to the actuator bar 32 and blocks the second space 33b, is visible. As the cross-sectional view shows, the wedge stop 53b extending from the back leg 52b of the CPA insert 20 occupies the second space 33b and is prevented from moving axially toward the cable end 16 of the housing 12 by the block formed by the second connecting bar 13b connecting to the actuator bar 32. Similarly, the wedge stop 53a occupies the first space 33a between the first bar 34a of the lever 30 and the first connecting bar 13a. The wedge stop 53a is prevented from moving axially toward the cable end 16 of the housing 12 by the block formed by the portion of the first connecting bar 13a that connects to the actuator bar 32 of the lever 30.

Each wedge stop 53a, 53b is put in the corresponding first space 33a or second space 33b based on the movement of the tab 22 and the resulting rotation of the CPA insert 20 relative to the lever 30 during transition from the unlocked to the locked position. The rotation of the CPA insert 20 at the end closest to the cable end 16 of the housing 12 is down (clockwise). As discussed with reference to FIGS. 4 and 5, the rotation of the CPA insert 20 at the opposite end, closest to the connection end 14 of the housing 12, is up (counterclockwise) and moves the nose 26 up, above the engagement bar 36. In the unlocked position of the CPA insert 20, the wedge stops 53a, 53b are closer to the cable end 16 of the housing 12 and outside the first space 33a and the second space 33b.

FIG. 7A-7C show different views of the CPA insert 20 according to various embodiments of the present disclosure. FIG. 7A is an elevation view of the CPA insert 20, FIG. 7B is a perspective view of the CPA insert 20, and FIG. 7C is another perspective view of the CPA insert 20. The view in FIG. 7A is from the cable end 16 of a housing 12 into which the CPA insert 20 is inserted. Thus, the tail bar 24 is visible and obscures a view of the nose 26. The view in FIG. 7A shows that the wedge stops 53a, 53b, the back legs 52a, 52b from which they extend, the legs 54a, 54b, the retaining elements 28a, 28b at their ends, and the protruding guides 56a, 56b are all mirror-symmetric about a center of the CPA insert 20 along the axial direction (i.e., on each side of the main body 50).

In FIGS. 7B and 7C, the main body 50 and nose 26 are visible. These views show the protruding guide 56a on one side. The protruding guides 56a, 56b are on opposite sides of the main body 50 (extending from opposite side surfaces 57) between the legs 54a, 54b and the nose 26.

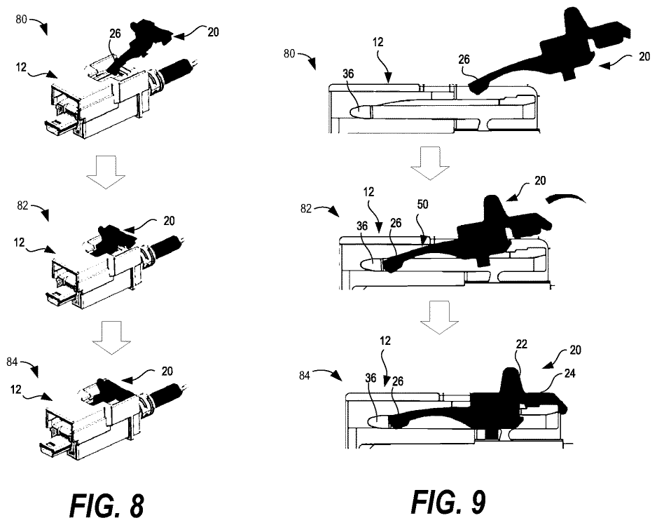

FIG. 8 is a flow diagram illustrating deployment of the CPA insert 20 in the housing 12 of the connector 10 according to several embodiments of the present disclosure. For explanatory purposes, “deployment” is used to refer to the process of inserting the CPA insert 20 into the housing 12 of the connector 10, and only a fully deployed CPA insert 20 is referred to as being in an unlocked position or locked position. According to various embodiments of the present disclosure, the CPA insert 20 must be deployed in the housing 12 of the connector 10 prior to engagement of the connector 10 with a receptacle 40. While the CPA insert 20 may be moved between a locked and unlocked position within the housing 12 prior to engagement of the connector 10 with a receptacle 40, the CPA insert 20 must be in the unlocked position during engagement, as discussed with reference to FIGS. 4 and 5.

At 80, the CPA insert 20 is shown angled relative to the housing 12 to insert the nose 26 of the CPA insert 20. At 82, the CPA insert 20 is guided within the housing 12 and, at 84, the CPA insert 20 is in place in the unlocked position shown in FIG. 1A, for example. During 82, as discussed with reference to FIG. 4, the legs 54a, 54b of the CPA insert 20 may be flexed toward each other to fit their retaining elements 28a, 28b through the open area 38 defined by the lever 30. At 84, the retaining elements 28a, 28b return to their unloaded (or less loaded) position to engage the first bar 34a and the second bar 34b of the lever 30. The protruding guides 56a, 56b are used to slide the CPA insert 20 to the position shown at 82 and 84, as further discussed.

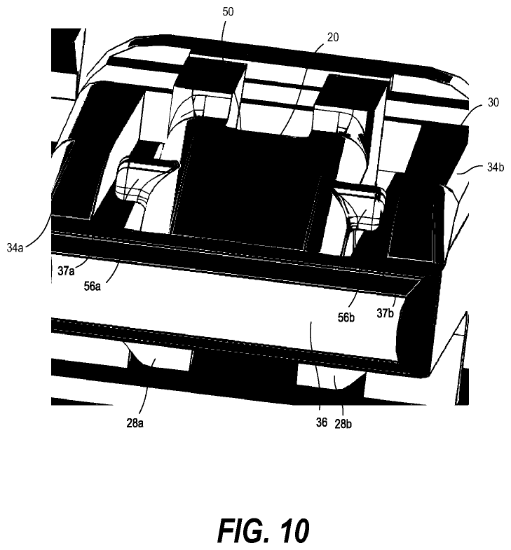

FIG. 9 shows cross-sectional views of the CPA insert 20 deployment flow illustrated in FIG. 8. At 80, the CPA insert 20 is shown angled relative to the housing 12 with the nose 26 entering an opening in the housing 12. At 82, the nose 26 of the CPA insert 20 is shown to reach the engagement bar 36 of the lever 30 with the main body 50 of the CPA insert 20 still angled. A different view of this position is shown in FIG. 10. At 84, the tail bar 24 may be pushed down toward the housing to rotate the CPA insert 20 (clockwise) within the housing 12, as shown. From this unlocked position of the CPA insert 20, insertion of the plug 42a into a socket 42b of a receptacle 40 results in the nose 26 of the CPA insert 20 being positioned above a ridge 43 of the receptacle 40, as shown in FIG. 4. Then, pushing the tab 22, as discussed with reference to FIGS. 4 and 5, results in the locked position of the CPA insert 20 shown in FIG. 5.

FIG. 10 is a partial perspective view clarifying a role of the protruding guides 56a, 56b during the deployment of the CPA insert 20 into the housing 12, as illustrated in FIG. 8. The position shown in FIG. 10 may correspond with the position at 82 in the deployment flow illustrated in FIGS. 8 and 9. That is, the nose 26 of the CPA insert 20 is behind the engagement bar 36 in the perspective of FIG. 10, as shown at 82 in the cross-sectional view of FIG. 9. The protruding guide 56a is visible in FIG. 10 and is shown on a first ledge 37a extending from the first bar 34a of the lever 30. Similarly, protruding guide 56b is positioned on a second ledge 37b extending from the second bar 34b of the lever 30.

The protruding guides 56a, 56b extend far enough on the sides (laterally) to overlap with the ledges 37a, 37b. The protruding guides 56a, 56b are caught on the first ledge 37a and the second ledge 37b, respectively, to prevent the nose 26 of the CPA insert 20 from rotating (counterclockwise) too far below the engagement bar 36 of the lever 30. If that happens, the ridge 43 of the receptacle 40 is prevented from pushing up the nose 26 to the position shown in FIG. 4 and is, instead, obstructed by the nose 26. Thus, the connector 10 and the receptacle 40 could not properly couple without the protruding guides 56a, 56b keeping the CPA insert 20 in the position shown at 82 in FIG. 9 during deployment. At the position shown at 84 in FIGS. 8 and 9, when deployment of the CPA insert 20 is complete, the nose 26 is level with the engagement bar 36 and the protruding guides 56a, 56b are above and not contacting the first ledge 37a and the second ledge 37b.

Embodiments of the CPA insert 20 discussed with reference to FIGS. 1A through 10 include features to couple the CPA insert 20 to the lever 30 and housing 12 of the connector 10. For example, wedge stops 53a, 53b of the CPA insert 20 act as pre-engagement stoppers that interact with the first connecting bar 13a and second connecting bar 13b of the lever 30 to retain the CPA insert 20 in the housing 12 of the connector 10 in the unlocked position, as shown in FIG. 6. The nose 26 of the CPA insert 20 facilitates operation of the CPA insert 20 as a secondary retention mechanism by preventing the engagement bar 36 of the lever 30 from being raised when in the locked position, as shown in FIG. 2 and discussed with reference to FIG. 5. The tab 22 encounters the housing 12 in the locked position of the CPA insert 20 to prevent the CPA insert 20 from being pushed too far into the housing 12, as shown in FIG. 1B. These features are exemplary rather than limiting and many variations that perform the above-noted functions are possible.

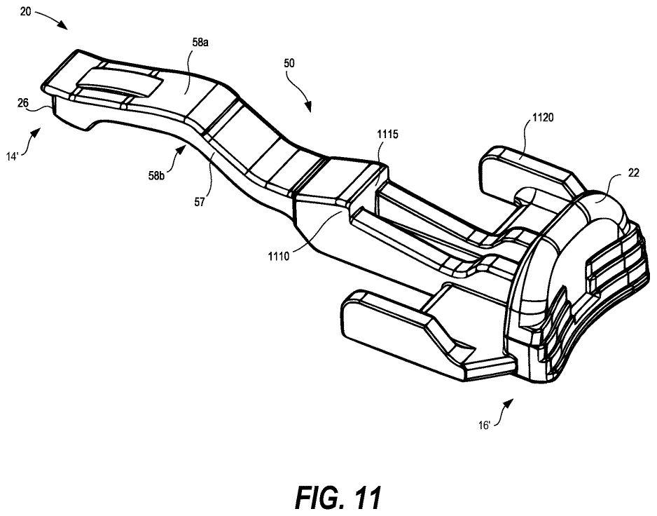

FIG. 11 is a perspective view of a CPA insert 20 according to various embodiments. Aspects of the embodiments that are variations of features of the CPA insert 20 discussed with reference to FIGS. 1A through 10 are highlighted. The CPA insert 20 in FIG. 11 has a main body 50 that extends in the axial direction from an end 16′ that is closest to the cable end 16 of the housing 12 of the connector 10, when the CPA insert 20 is engaged in the housing 12, to an opposite end 14′ that is closest to the connection end 14 of the housing 12. As discussed with reference to FIG. 4, for example, the main body 50 has a top surface 58a, a bottom surface 58b, opposite the top surface 58a, and side surfaces 57 according to the orientation in FIG. 11. The two side surfaces 57 are perpendicular to the top surface 58a and bottom surface 58b and are on opposite sides of the top surface 58a and bottom surface 58b. Unlike the main body 50 of the embodiment shown in FIG. 4, the main body 50 shown in FIG. 11 has a top surface 58a that is curved like the bottom surface 58b.

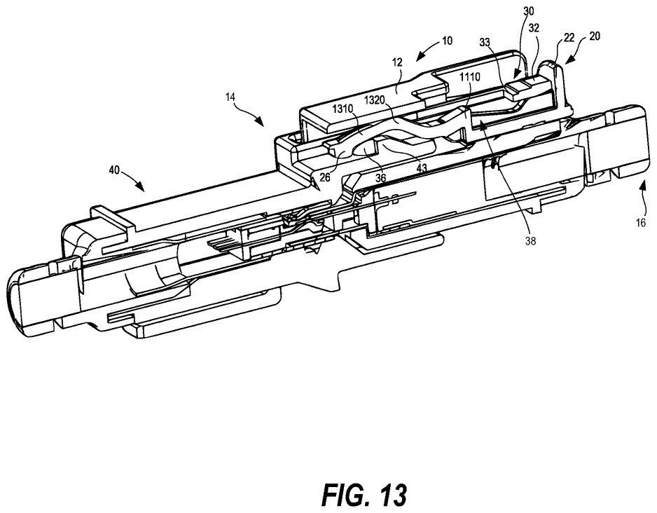

At the end 14', the CPA insert 20 includes a nose 26. As illustrated in FIG. 13, in the locked position, the nose 26 prevents the engagement bar 36 of the lever 30 of the connector 10 from being raised up. This reinforces the primary lock mechanism, which involves the engagement bar 36 preventing the ridge 43 of the receptacle 40 from being pulled back to disengage the receptacle 40 from the connector 10. As noted with reference to FIG. 4, the thickness of the nose 26 and the width of the main body 50 may be limited by the space within the housing 12.

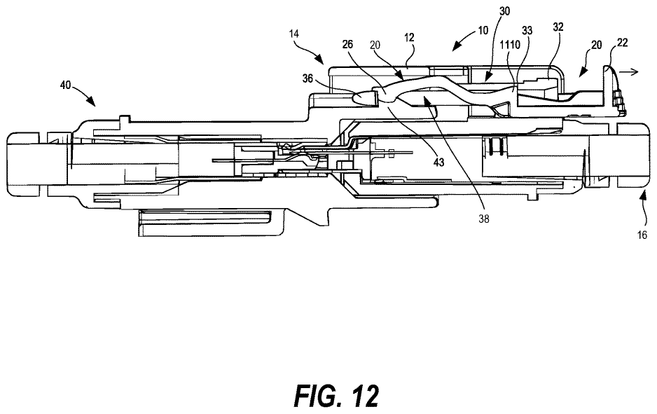

A pre-engagement retention feature 1110 is shown between the ends 14′, 16′. The pre-engagement retention feature 1110 is a substantially straight vertical projection, as shown in the side view of FIG. 12. That is, the wall 1115 may be straight. The projection is perpendicular to the (axial) direction in which the main body 50 extends. In alternate embodiments, the pre-engagement retention feature 1110 may be angled. That is, the wall 1115 may be inclined. As discussed with reference to FIG. 12, the height of the pre-engagement retention feature 1110 facilitates retention of the CPA insert 20 in the connector 10.

Like the wedge stops 53a, 53b of the exemplary CPA insert 20 shown in FIG. 6, the pre-engagement retention feature 1110 interacts with the lever 30 to keep the CPA insert 20 in the housing 12 of the connector 10 in the unlocked position. FIG. 12 shows the pre-engagement (unlocked) position. Unlike the embodiments in which the tab 22 is between the nose 26 and the wedge stops 53a, 53b, the tab 22 is at the end 16′, according to the embodiments shown in FIGS. 11-14, and the pre-engagement retention feature 1110 is between the nose 26 and the tab 22. Based on its position, the tab 22 prevents the CPA insert 20 from being pushed into the housing 12 of the connector 10, past the locked position, by engaging with the lever 30, as shown in FIG. 13. This is a variation of the embodiments associated with FIGS. 1A and 1B, in which the tab 22 engages with the housing 12.

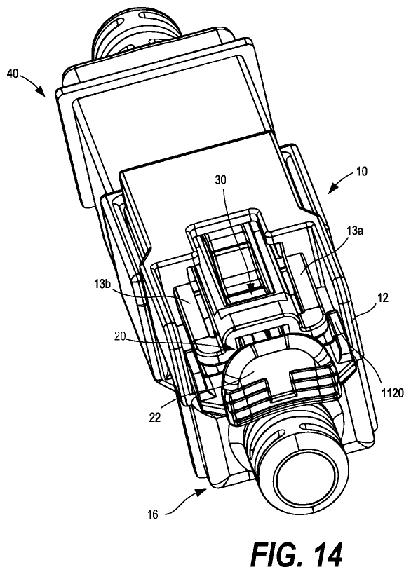

The CPA insert 20 also includes guiding features 1120 on each side of the main body 50 that are further discussed with reference to FIG. 14. The guiding features 1120 are vertical projections, as shown in FIG. 11. While the guiding features 1120 and the pre-engagement retention feature 1110 all project in a direction that is perpendicular to the axial direction in which the main body 50 extends, the pre-engagement retention feature 1110 extends laterally across the main body 50, while the guiding features 1120 extend axially, parallel to the main body 50.

FIG. 12 is a cross-sectional view of the connector 10 coupled with the receptacle 40, showing an unlocked position of the CPA insert 20 of FIG. 11. The second bar 34b of the lever 30 is removed to show the nose 26 of the CPA insert 20 in the open area 38 defined by the first bar 34a, second bar 34b, engagement bar 36, and actuator bar 32 of the lever 30. The primary locking mechanism is shown to be engaged. That is, the ridge 43 of the receptacle 40 is held in the open area 38 by the engagement bar 36 of the lever 30. The nose 26 of the CPA insert 20 is on the ridge 43 in the pre-engagement (unlocked) state.

As previously noted, the height of the projection that forms the pre-engagement retention feature 1110 facilitates retention of the CPA insert 20 in the housing 12 of the connector 10. The height of the pre-engagement retention feature 1110 is selected to enter the open area 38 of the lever 30 and then be held in the open area 38. That is, the pre-engagement retention feature 1110 can slide into the housing 12 under the actuator bar 32 of the lever 30. Once the pre-engagement retention feature 1110 is in the open area 38, as shown in FIG. 12, the top of the pre-engagement retention feature 1110 is blocked from pull-back, in the direction indicated by the arrow, by the inside edge 33 (i.e., an edge closest to the open area 38) of the actuator bar 32 of the lever 30. That is, relative arrangement of the pre-engagement retention feature 1110 and the actuator bar 32 prevents separation of the CPA insert 20 from the connector 10.

FIG. 13 is a cross-sectional view of the connector 10 coupled with the receptacle 40, showing a locked position of the CPA insert 20 of FIG. 11. As in FIG. 12, the open area 38 of the lever 30 is exposed because the second bar 34b of the lever 30 is removed. In the locked position, the nose 26 is pushed over the engagement bar 36 of the lever 30. The primary lock mechanism for engagement of the connector 10 and receptacle 40, which entails the engagement bar 36 holding the ridge 43 in the open area 38, is still in place. With the nose 26 in the locked position, the engagement bar 36 is prevented from being raised by pushing down on the actuator bar 32 of the lever 30.

That is, a first section 1310 of the CPA insert 20 adjacent to the nose 26 is positioned on (i.e., over, on top of) the engagement bar 36. In addition, a second section 1320 of the CPA insert 20, which is a curved section of the main body 50, may contact or nearly contact the housing 12 above. This prevents disengagement of the engagement bar 36 and ridge 43 of the receptacle 40, as also discussed with reference to FIG. 5. That is, the engagement bar 36 cannot be raised to allow withdrawal of the ridge 43, because raising the first section 1310 of the CPA insert 20, which is positioned on the engagement bar 36, is prevented by the second section 1320 of the CPA insert 20 being too close to the housing 12 above it. As also shown, the tab 22 is blocked from being pushed further into the housing 12 of the connector 10 by the actuator bar 32 of the lever 30.

FIG. 14 is a perspective view of a connector 10 with the CPA insert 20 of FIG. 11. The view is from the cable end 16 of the connector 10. This perspective shows the first connecting bar 13a and second connecting bar 13b on each side of the lever 30. The guiding features 1120 on each side of the CPA insert 20 slide between the first connecting bar 13a or the second connecting bar 13b and the housing 12. Thus, the guiding features 1120 ensure proper lateral alignment of the CPA insert 20 within the housing 12 of the connector 10.

The features, structures, or characteristics described above may be combined in one or more embodiments in any suitable manner, and the features discussed in the various embodiments are interchangeable, if possible. In the following description, numerous specific details are provided in order to fully understand the embodiments of the present disclosure. However, a person skilled in the art will appreciate that the technical solution of the present disclosure may be practiced without one or more of the specific details, or other methods, components, materials, and the like may be employed. In other instances, well-known structures, materials, or operations are not shown or described in detail to avoid obscuring aspects of the present disclosure.

Although the relative terms such as “on,” “below,” “upper,” and “lower” are used in the specification to describe the relative relationship of one component to another component, these terms are used in this specification for convenience only, for example, as a direction in an example shown in the drawings. It should be understood that if the device is turned upside down, the “upper” component described above will become a “lower” component. When a structure is “on” another structure, it is possible that the structure is integrally formed on another structure, or that the structure is “directly” disposed on another structure, or that the structure is “indirectly” disposed on the other structure through other structures.

In this specification, the terms such as “a,” “an,” “the,” and “said” are used to indicate the presence of one or more elements and components. The terms “comprise,” “include,” “have,” “contain,” and their variants are used to be open ended, and are meant to include additional elements, components, etc., in addition to the listed elements, components, etc. unless otherwise specified in the appended claims.

The terms “first,” “second,” etc. are used only as labels, rather than a limitation for a number of the objects. It is understood that if multiple components are shown, the components may be referred to as a “first” component, a “second” component, and so forth, to the extent applicable.

Combinatorial language, such as “at least one of X, Y, and Z” or “at least one of X, Y, or Z,” unless indicated otherwise, is used in general to identify one, a combination of any two, or all three (or more if a larger group is identified) thereof, such as X and only X, Y and only Y, and Z and only Z, the combinations of X and Y, X and Z, and Y and Z, and all of X, Y, and Z. Such combinatorial language is not generally intended to, and unless specified does not, identify or require at least one of X, at least one of Y, and at least one of Z to be included. The terms “about” and “substantially,” unless otherwise defined herein to be associated with a particular range, percentage, or related metric of deviation, account at least for some manufacturing tolerances between a theoretical design and a manufactured product or assembly, such as the geometric dimensioning and tolerancing criteria described in the American Society of Mechanical Engineers (ASME®) Y14.5 and the related International Organization for Standardization (ISO®) standards. Such manufacturing tolerances are still contemplated, as one of ordinary skill in the art would appreciate, although “about,” “substantially,” or related terms are not expressly referenced, even in connection with the use of theoretical terms, such as the geometric “perpendicular,” “orthogonal,” “vertex,” “collinear,” “coplanar,” and other terms.

The above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

Therefore, the following is claimed:

1. A connector comprising:
a housing comprising:
a cable end;
a connection end, opposite the cable end; and
a lever comprising:
an actuator bar closest to the cable end;
an engagement bar closest to the connection end; and
a first connecting bar and a second connecting bar extending between the actuator bar and the engagement bar with an open area framed by the actuator bar, the first bar, the engagement bar, and the second bar; and
a connector position assurance (CPA) insert comprising:
a main body extending between an end closest to the cable end and an end closest to the connection end of the housing when inserted in the housing; and
a pre-engagement retention feature arranged between the end closest to the cable end and the end closest to the connection end to be positioned in the open area and engage the actuator bar of the lever in an unlocked position of the CPA insert, wherein
the actuator bar prevents separation of the CPA insert from the housing.

2. The connector according to claim 1, wherein the pre-engagement retention feature is a projection extending from the main body in a direction perpendicular to the direction in which the main body extends.

3. The connector according to claim 1, wherein the CPA insert further comprises a nose at the end of the main body closest to the connection end of the housing when inserted in the housing.

4. The connector according to claim 3, wherein, in the unlocked position of the CPA insert, the nose is arranged to be positioned in the open area and engaged with the engagement bar of the lever.

5. The connector according to claim 3, wherein, in a locked position of the CPA insert, a first section of the CPA insert is arranged to be positioned over the engagement bar of the lever.

6. The connector according to claim 1, wherein the CPA insert further comprises a tab at the end of the main body closest to the cable end of the housing when inserted in the housing.

7. The connector according to claim 6, wherein, in a locked position of the CPA insert, the tab is positioned to engage with the actuator bar of the lever and prevent the CPA insert from moving further into the housing.

8. The connector according to claim 1, wherein the CPA insert further comprises guiding features on each side of the main body.

9. The connector according to claim 8, wherein each guiding feature is positioned to slide between the first connecting bar or the second connecting bar of the lever and a wall of the housing.

10. A connector position assurance (CPA) insert for deployment in a connector, the connector position assurance insert comprising:
a main body extending in an axial direction between a first end and a second end;
a nose at the first end;
a tab at the second end; and
guiding features on each side of the main body, wherein
each of the guiding features extends parallel to the main body and is projected in a direction perpendicular to the axial direction.

11. The CPA insert according to claim 10, further comprising a pre-engagement retention feature arranged between the nose and the tab, wherein
the pre-engagement retention feature extends across the main body and is projected in a direction perpendicular to the axial direction.

12. The CPA insert according to claim 10, wherein the main body includes a curved section.

13. A connector position assurance insert for deployment in a connector, the connector position assurance insert comprising:
a main body extending in an axial direction between a first end and a second end;
a nose at the first end;
a tail bar at the second end;
a first leg on a first side of the main body; and
a second leg on a second side, opposite the first side, of the main body, the first leg and the second leg extending in a depth direction from the main body and comprising a first retaining element and a second retaining element, respectively, at a depth farthest from the main body, wherein
the first retaining element and the second retaining element are pivot points for rotation of the connector position assurance insert.

14. The connector position assurance insert according to claim 13, wherein
the first retaining element and the second retaining element are snap-fit latches that hold the connector position assurance insert in the connector, and
the connector position assurance insert rotates from an unlocked position to a locked position in the connector.

15. The connector position assurance insert according to claim 14, further comprising:
a first back leg and a second back leg extending in a depth direction from the tail bar;
a first wedge stop extending from a portion of the first back leg; and
a second wedge stop extending from a portion of the second back leg.

16. The connector position assurance insert according to claim 15, wherein the first wedge stop and the second wedge stop are held in a first space and a second space, respectively, in the locked position of the connector.

17. The connector position assurance insert according to claim 15, wherein the first wedge stop and the second wedge stop are rotated into a first space and a second space, respectively, when the connector position assurance insert rotates from the unlocked position to the locked position in the connector.

18. The connector position assurance insert according to claim 13, further comprising a first protruding guide and a second protruding guide extending laterally from opposite sides of the main body.

19. The connector position assurance insert according to claim 18, wherein the first protruding guide is between the nose and the first leg and the second protruding guide is between the nose and the second leg.

20. The connector position assurance insert according to claim 13, further comprising a tab extending outside a housing of the connector when the connector position assurance insert is deployed in the connector.
